(19) United States
(12) Patent Application Publication
(10) Pub. No.: US 2003/0222142 A1
(43) Pub. Date: Dec. 4, 2003

(54) Retrofit enhancement device for a hand-held data collection unit

(75) Inventor: Dennis J. Stevens, Little Meadows, PA (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed Martin Corporation

(21) Appl. No.: 10/161,115

(22) Filed: May 31, 2002

(51) Int. Cl. G06F 17/60; G06K 7/10

(52) U.S. Cl. 235/385; 235/472.02

(57) ABSTRACT

An apparatus (112) is used with a portable data collection device (111) and a stationary central monitoring station. The apparatus (112) includes an electronic transmitter/receiver that communicates with the central monitoring station, a data collector (162, 164, 166, or 168) that collects data, and an infrared communication port (176). The data is transferred to the portable data collection device (111) through the infrared communication port (176). The apparatus (112) either routes the data to the portable data collection device (111) or to the electronic transmitter/receiver of the apparatus (112). The electronic transmitter/receiver of the apparatus (112) wirelessly transfers the data to the central monitoring station.

### FIELD OF INVENTION

The present invention is directed to an electronic data collection system and, more particularly, to an enhancement apparatus for an existing hand-held electronic data collection device.

### BACKGROUND OF THE INVENTION

A conventional data collection system, as illustrated by U.S. Pat. No. 5,410,141 to Koenck et al., includes a hand-held unit operating from battery power and functioning to collect and process data by a sequence of automated and/or manual operations. A typical automated process is the non-contact scanning of bar code data by means of a cyclically deflected laser beam or an image photosensor of the CCD type. Once a valid bar code reading has been obtained, a keypad may be manually operated to indicate an associated quantity. The user may then manually initiate a further operation, for example, the on-line transmission of the data to a remote host computer by a known means such as a radio frequency communications link.

It would be desirable to have a basic data collection system, which is lightweight and compact, and which could be readily retrofitted with an apparatus for further on-line wireless communications and other functions, as needed. The resulting data capture system would be versatile and particularly suitable for small-scale operations where low cost is a major objective, and versatility of the system is especially advantageous. Furthermore, in order to realize the benefits of mass production, it would be desirable, from the manufacturer's standpoint, if a basic computerized system configuration could be readily adapted to the needs of diverse end users by the selective addition of a low cost apparatus retrofitted onto the existing system.

### SUMMARY OF THE INVENTION

In accordance with one aspect of the present invention, an apparatus is used with a portable data collection device and a stationary central monitoring station. The apparatus includes an electronic transmitter/receiver that communicates with the central monitoring station, a data collector that collects data, and an infrared communication port. The data is transferred to the portable data collection device through the infrared communication port. The apparatus either routes the data to the portable data collection device or to the electronic transmitter/receiver of the apparatus. The electronic transmitter/receiver of the apparatus wirelessly transfers the data to the central monitoring station.

In accordance with another aspect of the present invention, a method is provided for collecting data. The method includes the steps of: providing an existing data collector; removing a power source from the existing data collector; replacing the power source with a new device, the new device including a power source and a means for collecting data; transferring data between the existing data collector and the new device through an infrared communication port; and supplying power to both the existing data collector and the new device from the power source in the new device.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic diagram of an apparatus in accordance with the present invention;

FIG. 2 is a schematic diagram of several operational steps utilizing the apparatus of FIG. 1;

FIG. 3 is a schematic perspective view of an apparatus in accordance with one embodiment of the apparatus of FIG. 1;

FIG. 4 is a schematic view of the apparatus of FIG. 3 under a different condition;

FIG. 5 is a schematic side view of the apparatus of FIG. 3;

FIG. 6 is schematic perspective view of the apparatus of FIG. 3; and

FIG. 7 is a schematic perspective view of an existing part of the apparatus of FIG. 6.

### DESCRIPTION OF AN EXAMPLE EMBODIMENT

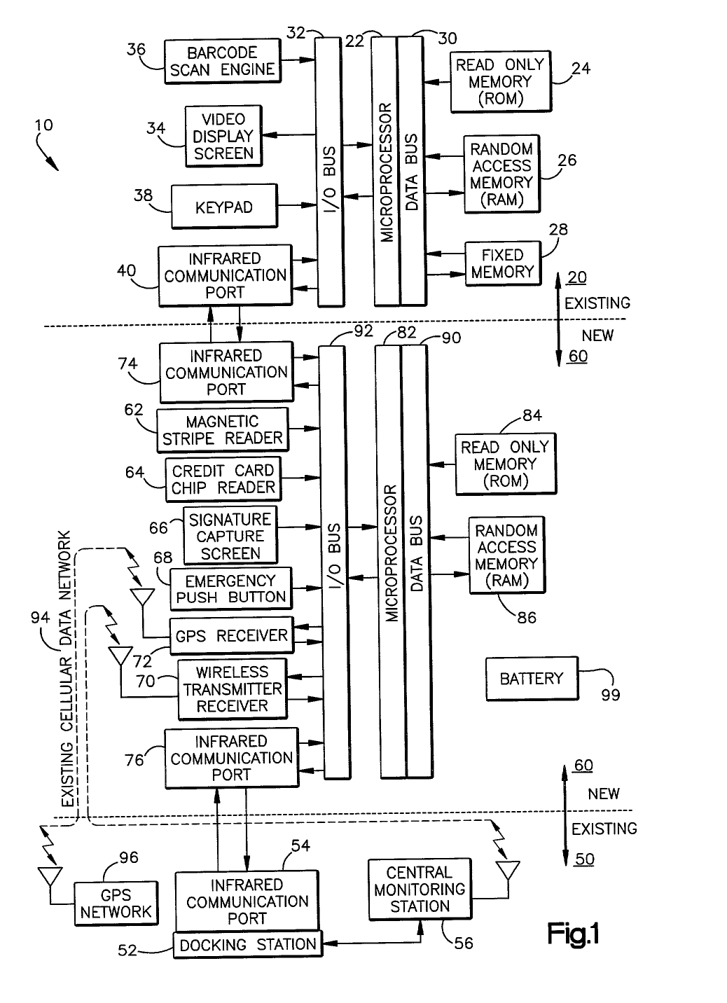

In accordance with the present invention, FIG. 1 schematically illustrates a system 10 for collecting and storing data and selectively communicating that data and other information to an existing remote communication system 50. The system 10 comprises an existing, handheld portable part 20 and a new portable part 60 (or apparatus) retrofitted onto the existing, handheld part for communicating with the existing system 50. A new handheld system 10 is formed by this retrofitting.

The handheld part 20 includes a microprocessor 22 in communication with read only memory (ROM) 24, random access memory (RAM) 26, fixed memory 28 for data storage, an internal communication data bus 30, and an input/output (I/O) communication bus 32. The handheld part 20 further includes a video display screen 34 (typically a liquid crystal display), a bar code scan engine or reader 36, a manually operable keypad 38 or keyboard, and an existing external infrared communication port 40 for communicating with an external device (such as the remote system 50 or the new part 60 as described below).

When utilized alone, the existing handheld part 20 collects data through the bar code reader 36 scanning bar codes and an operator punching in information to the keypad 38. The handheld part 20 then immediately routes that data to the input/output bus 32. The display screen 34 provides video feedback to the user through the input/output bus 32. The microprocessor 22 receives the collected data from the input/output bus 32 and routes it through the internal data bus 30 to the random access memory 26 and the fixed memory 28 as determined by the particular control algorithm and the particular data. A read only memory 24 provides the microprocessor 22 with information as needed.

At the end of a data collection cycle (i.e., the end of a work shift), the handheld part 20 may communicate the stored data to the communication system 50. The existing communication system 50 includes a stationary docking station 52 with an existing infrared communication port 54 for receiving data directly (i.e., a “handshake” transaction) from the existing infrared communication port 40 of the handheld part 20. The docking station 52 may then communicate the data to an existing central monitoring station 56 such as a computer through a hardwire connection. Software updates may also be uploaded to the handheld part 20 at this time through the ports 40, 54. The existing handheld part 20 is limited to the batch communication described above. Also, a power source 99, such as a battery pack, of the handheld part 20 may be recharged at this time by the docking station 52.

When the new portable part 60 is retrofitted onto the existing, handheld part 20, the combined handheld system 10 may retain the batch communication capability as well as provide additional capabilities through the new portable part. The new portable part 60 may include a magnetic stripe reader 62, a credit card chip reader 64, a signature capture screen 66, an emergency pushbutton 68, a wireless transmitter/receiver 70 such as an RF transceiver, a global positioning system (GPS) receiver 72, an internal infrared communication port 74 for communication with the infrared communication port 40 of the existing handheld device 20, and an external infrared communication port 76 for communication with the infrared communication port 54 of the docking station 52. The new portable part 60 further includes an additional microprocessor 82 in communication with read only memory (ROM) 84, random access memory (RAM) 86, an internal communication data bus 90, and input/output (I/O) communication bus 92.

When the new portable part 60 is retrofitted onto the handheld part 20, thereby forming the single combined unit, or handheld system 10, the apparatus provides increased data collection capability and increased communication capability. The system 10 may now read data from a magnetic stripe (i.e., a credit card, debit card, etc.) by placing the magnetic stripe in a corresponding slot of the magnetic stripe reader 62. The data may then be transferred through the input/output bus 92 to the microprocessor 82. The microprocessor 82 may then determine whether to store the data in the fixed memory 28 of the handheld part 20 by transferring the data through the infrared communication ports 40, 74. Alternatively, the microprocessor 82 may determine that the data should be immediately transferred to the central monitoring station 56 through the wireless transmitter/receiver 70.

Further, the system 10 may now read data from an electronic chip (i.e., a credit card) by placing the chip in a corresponding slot of the chip reader 64. The data may then be transferred through the input/output bus 92 to the microprocessor 82. The microprocessor 82 may then determine whether to store the data in the fixed memory 28 of the handheld part 20 by transferring the data through the infrared communication ports 40, 74. Alternatively, the microprocessor 82 may determine that the data should be immediately transferred to the central monitoring station 56 through the wireless transmitter/receiver 70.

Also, the system 10 may now capture the signature of a person (i.e., a package recipient) when the person records their signature by running a stylus across the capture screen 66. The data may then be transferred through the input/output bus 92 to the microprocessor 82. The microprocessor 82 may then determine whether to store the data in the fixed memory 28 of the handheld part 20 by transferring the data through the infrared communication ports 40, 74. Alternatively, the microprocessor 82 may determine that the data should be immediately transferred to the central monitoring station 56 through the wireless transmitter/receiver 70. This signature capture feature of the retrofitted system 10 is particularly useful since the existing handheld device 20, used alone, typically scans a bar code of a paper label that has been signed by a package recipient and both the bar code (electronically) and the paper label must be saved for end of the shift processing.

If the operator of the new handheld system 10 needs assistance, the operator may depress the emergency pushbutton 68. The time and location of this occurrence may be transferred directly to the central monitoring station 56 via the wireless transmitter/receiver 70. The time and location data may also be transferred to, and stored in, the fixed memory 28 of the handheld device 20 through the infrared communication ports 40, 74.

Any data collected by the system 10 may be transferred, through the wireless transmitter/receiver 70, to the central monitoring station 56 at any time depending upon the specific control algorithm of the microprocessors 22, 82. This includes data collected by the data collection devices 36, 38 of the existing, handheld part 20 or the data collection devices 62, 64, 66, 68 of the new portable part 60, as determined by the newly configured microprocessor 22 and the new microprocessor 82. Any future reconfiguration of the microprocessors 22, 82 may be uploaded through the infrared communication ports 54, 76 when the system 10 is placed in the docking station 52.

The microprocessor 82 of the new portable part 60 may also communicate directly with a cellular data network 94 through the global positioning receiver 72 for obtaining global positioning information (from a GPS network 96) for chronologically indexing data stored in the fixed memory 28 and/or for communicating (through the wireless transmitter/receiver 70) the position of the system 10 to the central monitoring station 56 at any specific time.

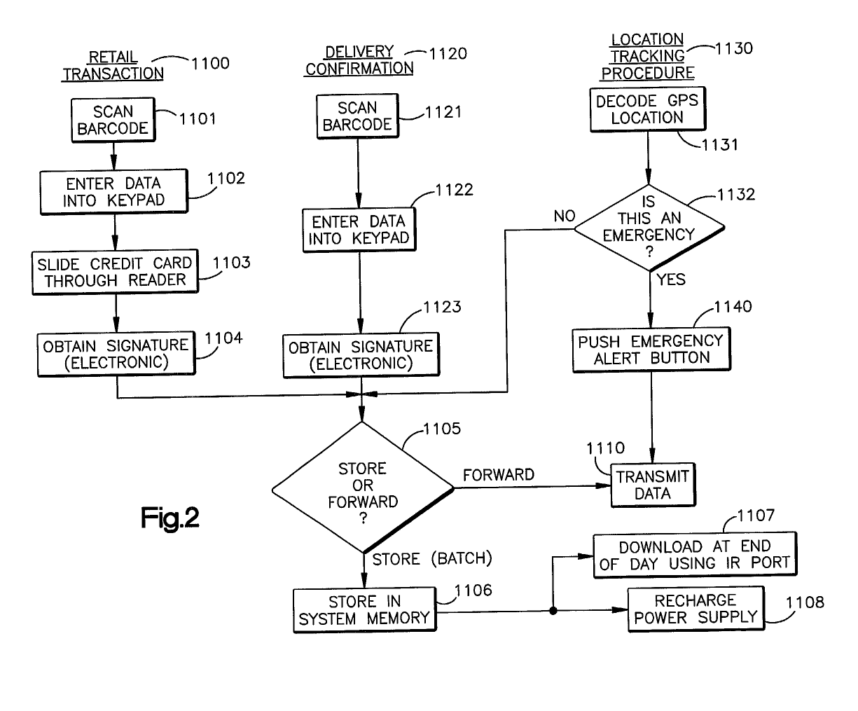

As viewed in FIG. 2, the system 10 may be utilized for several types of information and commercial operations. For a retail transaction 1100, in step 1101, the bar code of a package may be scanned by the bar code reader 36. Following step 1101, the transaction proceeds to step 1102. In step 1102, the data of a prospective recipient of the package may be entered into the keypad 38. Following step 1102, the transaction proceeds to step 1103. In step 1103, the magnetic stripe of a credit card may be read by the magnetic stripe reader 62 or, alternatively, if the credit card has a data chip in it, the chip may be read by the credit card chip reader 64. Following step 1103, the transaction proceeds to step 1104. In step 1104, the signature of the prospective recipient may be captured by the capture screen 66. Following step 1104, the transaction proceeds to step 1105. In step 1105, the microprocessors 22, 82 decide between the options of storing the collected bar code, keypad, credit card, and signature data in the fixed memory 28 (for download at the end of the shift) or wirelessly forwarding the bar code, keypad, credit card, and signature data immediately to the central monitoring station 56.

Following step 1105, if the storing option is chosen, the transaction proceeds to step 1106. In step 1106, the bar code, keypad, credit card, and signature data is stored in the fixed memory 28 through communication across the internal infrared communication ports 40, 74. Following step 1106, the transaction proceeds to step 1107. In step 1107, the collected bar code, keypad, credit card, and signature data, along with other data collected throughout the shift of the user, is downloaded into the docking station 52 through the infrared communication ports 54, 76. Following (or simultaneous with) step 1107, the transaction proceeds to step 1108. In step 1108, the power supply (i.e., the battery pack 99) of the system 10 is recharged through the docking station 52.

Following step 1105, if the wireless forwarding option is chosen, the transaction proceeds to step 1110. In step 1110, the wireless transmitter/receiver 70 immediately transfers (i.e., through RF transmission) the collected bar code, keypad, credit card, and signature data to the central monitoring station 56 for approval/disapproval of the credit card information.

For a delivery confirmation 1120 of a package, in step 1121, the bar code of a package may be scanned by the bar code reader 36. Following step 1121, the confirmation proceeds to step 1122. In step 1122, other data of a prospective recipient of the package may be entered into the keypad 38. Following step 1122, the confirmation proceeds to step 1123. In step 1123, the signature of the prospective recipient may be captured by the capture screen 66. Following step 1123, the confirmation proceeds to step 1105. In step 1105, the microprocessors 22, 82 decide between the options of storing the collected bar code, keypad, and signature data in the fixed memory 28 (for download at the end of the shift) or wirelessly forwarding the bar code, keypad, and signature data immediately to the central monitoring station 56.

Following step 1105, if the storing option is chosen, the confirmation proceeds to step 1106. In step 1106, the bar code, keypad, and signature data is stored in the fixed memory 28 through communication across the internal infrared communication ports 40, 74. Following step 1106, the confirmation proceeds to step 1107. In step 1107, the collected bar code, keypad, and signature data, along with other data collected throughout the shift of the user (i.e., the above described retail transaction), is downloaded into the docking station 52 through the infrared communication ports 54, 76. Following (or simultaneous with) step 1107, the transaction proceeds to step 1108. In step 1108, the power supply of the system 10 is recharged through the docking station 52.

Following step 1105, if the wireless forwarding option is chosen, the transaction proceeds to step 1110. In step 1110, the wireless transmitter/receiver 70 immediately transfers (i.e., through RF transmission) the collected bar code, keypad, and signature data to the central monitoring station 56 for immediate confirmation of the delivery.

For an automated location tracking procedure 1130 for the system 10, in step 1131, the microprocessors 22, 82 cyclically decode a GPS signal received through the GPS receiver 72 for determining the geographic location of the system 10 at a specific time (i.e., a constantly updated position of the system 10). Following step 1131, the tracking procedure proceeds to step 1132. In step 1132, the user of the system 10 determines if there is an emergency situation and, if so, indicates such by depressing the emergency push button 68.

Following step 1132, if an emergency situation does not exist, the tracking procedure proceeds to step 1105. In step 1105, the storing option of the location and time data is chosen. Following step 1105, the tracking procedure proceeds to step 1106. In step 1106, the location and time data is stored in the fixed memory 28. Following step 1106, the tracking procedure proceeds to step 1107. In step 1107, the location and time data (i.e., an system travel log), along with other data collected throughout the shift of the user (i.e., the above described retail transaction and delivery confirmation), may be downloaded into the docking station 52 through the infrared communication ports 54, 76. Following (or simultaneous with) step 1107, the tracking procedure proceeds to step 1108. In step 1108, the power supply of the system 10 is recharged through the docking station 52.

Following step 1132, if an emergency situation does exist, in step 1140, the user depresses the emergency push button 68. Following step 1140, the tracking procedure proceeds to step 1110. In step 1110, the location and time data of the emergency is transmitted to the central monitoring station 56 through the wireless transmitter/receiver 70 so that instructions may be received through the wireless transmitter/receiver 70 and the display screen 34. The above described retail transaction, delivery confirmation, and location tracking procedure are just three examples of the multitude of operations the system 10 may perform in a wide variety of portable communication/data collection device applications.

In accordance with one embodiment of the present invention, FIG. 3 illustrates a portable hand-held data capture terminal 100. The terminal 100 has an elongated housing defined by a first existing part 111 and a second part 112. The elongate housing is sized such that a user may hold the terminal 100 comfortably in one hand for extended periods of time. The first part 111 may have a curved indentation 105 so that an operator may place part of the operator's hand within it in order to comfortably hold and/or balance the terminal 100 during operation, data collection and/or communication.

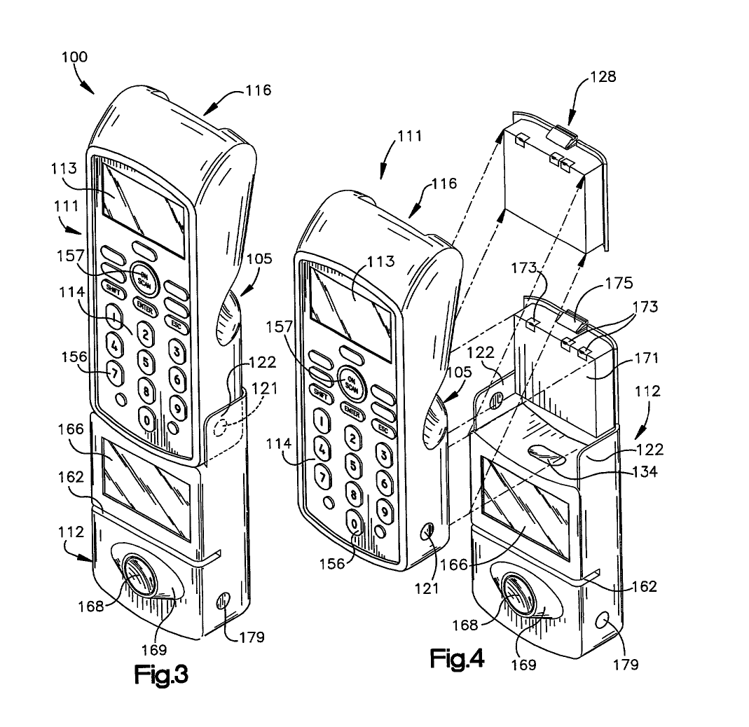

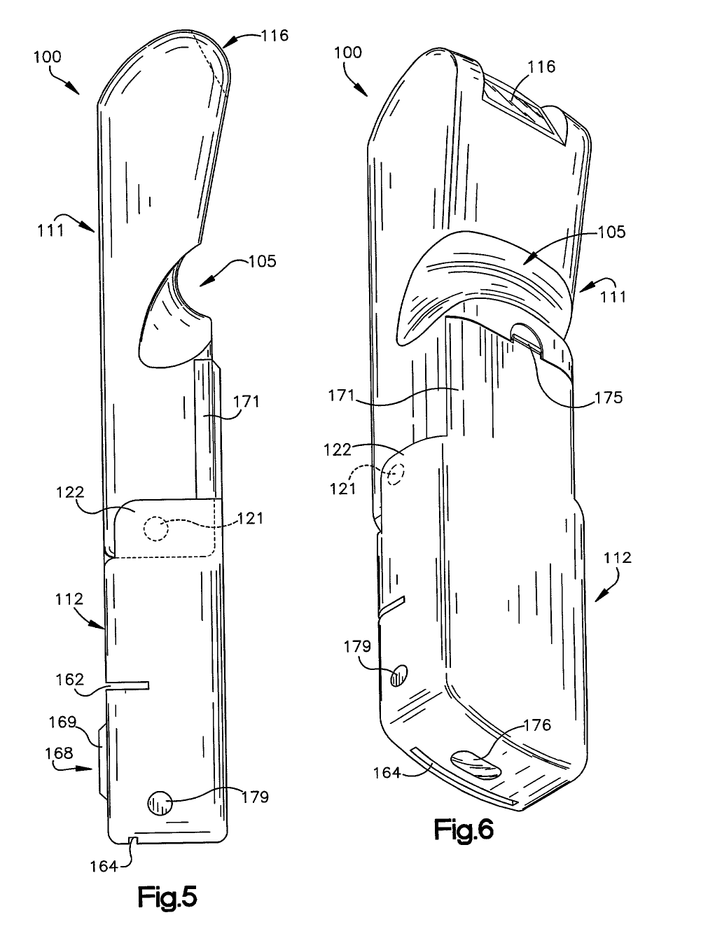

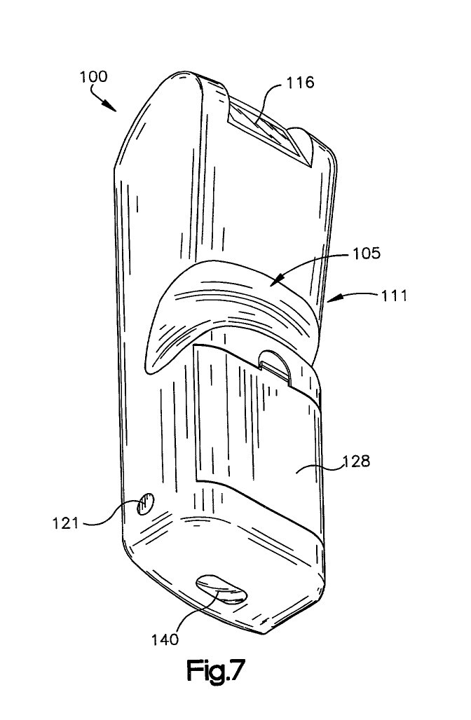

The first part 111 may be an existing device, or unit, typically powered by a rechargeable nickel-metal-hydride battery pack 128 (FIG. 4). The first part 111 of the terminal 100 provides a mounting platform for a display screen 113 (FIGS. 3 & 4) which may provide a visual indication of various types of information to a user. Typically, the video display 113 is a liquid crystal display (LCD) providing sixteen lines, with twenty characters per line, of display area. Alternatively, the display 113 may be a four-line type. The video display 113 may be mounted upon a printed circuit board (not shown) that is mounted or secured within the first part 111. In addition, the first part 111 may provide a mounting platform for a keypad 114 (FIGS. 3 & 4), having a plurality of keys 156 disposed thereon. Typically the keypad 114 is provided with either twenty-three or forty keys. The control and interface circuitry for the keypad 114 and memory for storing collected data may be contained on the printed circuit board mounted within the first part 111. The first part 111 may include a bar code reader 116 for scanning bar codes of packages, letters, etc. The bar code reader 116 may be activated by an “ON SCAN” button 157 located on the keypad 114.

The memory of the existing first part 111 may record the time, date, and bar code data of accountable mail packages; the time, date, and bar code data of printed labels signifying specific geographic locations; and/or the keypad entry of alphanumeric textual data representing a variety of logistics related information, as described above. The existing first part 111, acting alone, employs a batch processing approach to download the bar code data and alphanumeric textual data collected during the conduction of business. This is accomplished by placing the first part 111 into a docking station located in a fixed location at the workplace at the end of a work shift. The first part 111 may download collected data using an infrared communications port 140 located on the bottom exterior portion of the first part 111. A power source (i.e., the battery pack 128 in the first part 111) may be recharged during the docking period via smooth connectors 121 located on the sides of the first part 111.

The second part 112 may be a retrofit device, or unit. As described above, the second part 112 may attach to the lower portion of the first part 111 and provide electrical power and the added features of position location data, pushbutton emergency alerting, signature capture data, magnetic stripe data, electronic chip card data, and a wide area wireless communications capability (i.e., an RF transceiver). The retrofit second part 112 provides electrical power to the existing first part 111 by replacing the original battery pack 128 with the entire second part.

Location capability may be derived from the use of a Global Positioning System (GPS) receiver disposed in the second part 112. A magnetic stripe reader 162, electronic chip credit card reader 164, and emergency pushbutton 168 are also disposed on the second part 112. The second part 112 may further provide wireless communications capability with the nationwide data telecommunications infrastructure of multiple nationwide cellular data network common carriers.

The retrofitting of the second part 112 onto the first part 111 allows the operator of the new enhanced unit 100 to conduct normal and enhanced business transactions in real time in a manner consistent with the mobile nature of logistics operations. For example, the data capture terminal 100 may be integrated into another type of unit such as a two-wheeled, gyroscopically balanced cart for use prospectively by mail carriers (i.e., a SEGWAY).

One example of the use of this embodiment of the present invention is the handheld delivery confirmation communication system of postal operations. More particularly, the present invention (i.e., the combined first part 111 and second part 112) may be an existing delivery confirmation device (i.e., the first part 111) retrofitted with a new device (i.e., the second part 112) for the wireless exchange of delivery confirmation, two-way text, signature capture, magnetic stripe and electronic chip credit cards, emergency alerting, and position location information over a common carrier cellular data network.

A portable handheld data collection device for postal applications is known in the art (FIG. 7). This system collects and processes data in the form of bar coded indicia and alphanumeric text. The source data is obtained through manual scanning, automatic scanning, or image capture of printed single or multi-dimensional bar coded labels. The manual collection of alphanumeric textual information is entered into the keypad of the existing handheld data collection device.

The existing handheld data collection device (i.e., the first part 111), currently in use for postal operations, requires collected information to be downloaded from the handheld data collection device via a permanent desktop docking station. The existing device is typically placed in the docking station at the end of a workday. The information collected during the workday is then transmitted through the docking station using an infrared communication port 140 located at the bottom of the existing device. The infrared port 140, when placed in close proximity to a complimentary infrared port in the docking station initiates the transmittal and reception of information. The battery pack 128 of the existing handheld data collection device also may be recharged when placed in the docking station.

The existing device is not readily capable of remotely transmitting, in real time, the data collected during the workday. Also, the existing device is not capable of capturing written signature data, magnetic stripe data, electronic chip data of a credit card, user location data, sending out an emergency alert message indicating that the operator is in need of assistance, or receiving instructions for addressing that emergency (such as may appear on the video display screen 113). Although this enhanced functionality may be fully integrated into a replacement device for the existing device, cost of such a replacement would be undesirable.

Consequently, the coupling of the existing first part 111 with the retrofit second part 112 may provide the additional functionality described above for this postal application, without excessive cost, as well as other various applications. Such a system may operate with the existing first part 111 through the existing infrared communication port 140, and thereby not necessitate the complete replacement of the existing first part.

The coupling of the existing and retrofit devices is illustrated in FIGS. 3 and 4. The enhanced terminal 100 formed by the first part 111 and the second part 112 may include an internal infrared communication port 134 (FIG. 4), a rechargeable power source 171 (i.e., the battery pack 99 of FIG. 1) equivalent both physically and electrically to the existing battery pack 128, a wireless transmitter/receiver with internal antenna (not shown), a GPS receiver with internal antenna (not shown), external IR docking port 176, docking station power recharge contacts 179 (one shown) equivalent to the smooth connectors 121 of the existing first part 111, emergency pushbutton 168, emergency pushbutton guard 169, signature capture screen 166, magnetic stripe reader 162, and electronic chip card reader 164.

The second part 112 is retrofitted in the manner shown in FIG. 4 to the existing first part 111. The existing battery pack 121 is removed from the first part 111 and used elsewhere or discarded. The second part 112 is then inserted over the bottom of the first part 111 and rotated in a forward direction until the rechargeable battery pack 171 of the second part 112 is inserted and locked with a locking tab 175 into the location on the first part 111 formerly occupied by discarded battery pack 128. The resulting combination 100 is shown in FIG. 3.

The rechargeable power source 171 of the second part 112 supplies electrical power for both the second part 112 and the first part 111. Electrical power is transferred to the first part 111 through the metallic terminals 173 on the power source 171 of the second part 112. Electrical power to recharge the rechargeable power source 171 of the second part 112 is obtained through the mating of metallic contacts of the existing docking station with the metallic contacts 179 of the second part 112, just as the existing battery pack 128 has been recharged through the contacts 121. The existing docking station typically obtains electrical power from a separate hard-wired power supply.

Bar code and text data collected through the daily business transactions are stored within the memory (i.e., the fixed memory 28) of the first part 111. Information from the memory of the first part 111 may be internally routed to the infrared port 140 of the first part 111. The infrared port 140 (FIG. 7) of the first part 111 is in close proximity to the infrared port 134 (FIG. 4) of the second part 112 thereby enabling the transfer of information between the first part 111 and the second part 112. The infrared port 134 of the second part 112 may be connected to the wireless transmitter/receiver, which may broadcast information transferred from the first part 111 through the antenna to a common carrier cellular data network. Conversely, information broadcast by the common carrier cellular data network destined for the first part 111 may be received by the antenna and wireless transmitter/receiver and routed to the infrared port 134 of the second part 112, which communicates with infrared port 140 of the first part 111. When the combination of the first part 111 and the second part 112 are docked in the existing docking station, data may be downloaded and/or uploaded to the terminal 100 via the external infrared port 176 of the second part 112, which is in close proximity to infrared port of the existing docking station.

Position location information of the terminal 100 may be obtained from the Global Positioning System through the GPS antenna located within the second part 112. Signals from the antenna may be converted to digital form in a global positioning receiver (not shown) and routed through the infrared port 134 to the first part 111 via the infrared port 140. These signals may also be broadcast via the wireless transmitter/receiver and antenna to a remote manned or unmanned central monitoring station (i.e., the central monitoring station 56).

Emergency notification is initiated by pressing the pushbutton 158 on the second part 112. The pushbutton 158 is protected from accidental activation by the guard ring 159. Pressing the pushbutton 158 causes the operator's location to be captured via the global positioning receiver in the second part 112. This information, along with user identification, is immediately broadcast via wireless transmitter/receiver and antenna to the common carrier data network where it is routed to the remote central monitoring station.

Written signatures may be captured on the capture screen 166 on the second part 112. The signature may be digitized by the second part 112 and routed through the infrared ports 134, 140 to the first part 111. Credit cards bearing a magnetic stripe may be captured via the magnetic stripe reader 162. The data may be digitized by the second part 112 and routed through the infrared port 134 to the first part 111. Electronic chips embedded in credit cards may be read using the card reader 164 on the second part 112. The data may be digitized by the second part 112 and routed through the infrared port 134 to the first part 111.

Alternatively, the terminal 100 may format and encrypt this data under the control of an existing or an updated software algorithm. The terminal 100 may route the data to the wireless transmitter/receiver for transmittal to the common carrier cellular data network.

A system or apparatus in accordance with the present invention provides a fully integrated device utilizing the full capability of the existing data collector with several additional functions provided by the enhanced capability of the retrofitted device. The infrared communication ports 134, 140 enable complete communication between the first and second parts 111, 112 and a fluid functioning of the parts such that the parts act as one totally integrated unit.

In accordance with one aspect of the present invention, an apparatus 112 is used with an existing data collection device 111 and a stationary central monitoring station. The apparatus 112 includes an electronic transmitter/receiver that communicates with the central monitoring station and a data collector 162, 164, 166, or 168 that collects data. The apparatus 112 either routes the data to the existing data collection device 111 or to the electronic transmitter/receiver of the apparatus 112. The electronic transmitter/receiver of the apparatus 112 wirelessly transfers the data to the central monitoring station.

In accordance with another aspect of the present invention, a data collecting method includes the steps of: providing an existing data collector 111; removing a power source 128 from the existing data collector 111; replacing the power source 128 with a new device 112, the new device including a power source 171 and a means 162, 164, 166, or 168 for collecting data; transferring data between the existing data collector 111 and the new device 112 through an infrared communication port 134; and supplying power to both the existing data collector 111 and the new device 112 from the power source 171 in the new device 112.

In accordance with still another aspect of the present invention, a system 10 electronically collects, stores and transfers data. The system 10 includes a first device 20 and second device 60. The first device 20 electronically collects a first set of data. The second device 60 electronically collects a second set of data. The first set of data alternatively is temporarily stored by the first device 20 or immediately transferred through infrared communication to the second device 60 and transferred wirelessly from the second device to a remote central monitoring station 56. The second set of data is alternatively transferred to the first device 20 though infrared communication and temporarily stored by the first device or immediately transferred wirelessly to the remote central monitoring station 56.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for use with a portable data collection device and a stationary central monitoring station, said apparatus comprising:
an electronic transmitter/receiver that communicates with the central monitoring station;
a data collector that collects data; and
an infrared communication port, the collected data being transferred to the portable data collection device through said infrared communication port,
said apparatus either routing the collected data to the portable data collection device or to said electronic transmitter/receiver of said apparatus, said electronic transmitter/receiver of said apparatus wirelessly transferring the collected data to the central monitoring station.

2. The apparatus as set forth in claim 1 wherein said apparatus routes the collected data directly to the central monitoring station without the data being transferred to the portable data collection device.

3. The apparatus as set forth in claim 1 wherein said infrared communication port of said apparatus transfers the collected data through a corresponding infrared communication port on the portable data collection device.

4. The apparatus as set forth in claim 1 wherein said apparatus routes the collected data to a memory allocated for fixed data storage in the portable data collection device.

5. The apparatus as set forth in claim 1 wherein said data collector comprises a device selected from the group consisting of a magnetic stripe reader, a credit card chip reader, a signature capture screen, and a manually operable emergency push button.

6. The apparatus as set forth in claim 1 wherein said electronic transmitter/receiver utilizes radio frequency (RF) transmission and reception to communicate with the central monitoring station.

7. The apparatus as set forth in claim 6 further including a microprocessor for controlling the operation of said apparatus.

8. The apparatus as set forth in claim 1 further including a second infrared communication port for uploading and downloading the collected data between said apparatus and a docking station.

9. The apparatus as set forth in claim 8 wherein said second infrared communication port is disposed on an exterior portion of said apparatus.

10. The apparatus as set forth in claim 9 wherein said apparatus is recharged by the docking station.

11. A method for enhancing the capability of a data collection unit, said method comprising the steps of:
providing a portable data collector;
removing a power source from the portable data collector;
replacing the power source with a new device, the new device including a power source and a means for collecting data, the new device and the portable data collector together forming a single enhanced data collection unit;
transferring collected data between the portable data collector and the new device through an infrared communication port; and
supplying power to both the portable data collector and the new device from the power source in the new device.

12. The method as set forth in claim 11 further including the step of transferring collected data between the new device and a central monitoring station, said transferring step being conducted through wireless remote data transmission.

13. The method as set forth in claim 11 further including the step of recharging the power source in the new device, said recharging step including the placing of the data collection unit in a docking station.

14. The method as set forth in claim 13 further including the step of downloading information from the data collection unit to the docking station.

15. The method as set forth in claim 11 wherein said downloading step includes infrared communication between an infrared communication port on an exterior portion of the data collection unit and an infrared communication port on the docking station.

16. A system for electronically collecting, storing, and transferring data, said system comprising:
a first device that electronically collects a first set of data;
a second device that electronically collects a second set of data;
the first set of data alternatively being temporarily stored by said first device or immediately transferred to said second device through infrared communication and wirelessly transferred to a remote central monitoring station;
the second set of data alternatively being transferred to said first device through infrared communication and temporarily stored by said first device or immediately transferred wirelessly to the remote central monitoring station.

17. The system as set forth in claim 16 wherein the part of the first set of data and part of the second set of data being temporarily stored in said first device are downloaded through said second device to the central monitoring station as part of a batch download.

18. The system as set forth in claim 17 wherein the batch download includes a first transfer of data from said first device to said second device and a second transfer of data from said second device to the central monitoring station.

19. The system as set forth in claim 18 wherein the first transfer comprises infrared communication between said first device and said second device.

20. The system as set forth in claim 18 wherein the second transfer comprises infrared communication between said second device and the central monitoring station.
